(19) United States
(12) Patent Application Publication
(10) Pub. No.: US 2005/0258321 A1
(43) Pub. Date: Nov. 24, 2005

(54) Mounting bracket

(76) Inventors: Raymond Worrall, Wolverhampton (GB); Kenneth Gary Nicholls, Wolverhampton (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/104,817

(22) Filed: Apr. 13, 2005

Related U.S. Application Data
(63) Continuation-in-part of application No. 10/927,208, filed on Aug. 26, 2004.

(30) Foreign Application Priority Data
May 19, 2004 (GB) 0411100.1

(51) Int. Cl. F16M 11/00

(52) U.S. Cl. 248/201

(57) ABSTRACT

A mounting bracket for attaching an LCD screen to the underside of a surface comprises a first bracket component adapted to be mounted indirectly to said surface, a second bracket component adapted to be engaged to the LCD screen and a third bracket component in relatively slidable engagement with said first bracket component, and pivotally connected to said second bracket component. The second bracket component has a pair of lateral wings which can be moved into the first bracket component by pivoting the second bracket component relative to the third bracket component, and then sliding the third bracket component into the first bracket component.

This invention relates to a mounting bracket intended particularly, but not exclusively, for the mounting of an LCD screen to the underside of a cabinet or shelf.

Recent kitchen furniture designs have commonly included a liquid crystal television, e.g. one with a flat panel display screen, mounted to the underside of a kitchen cabinet. Generally the screen has a bracket fixed to the rear thereof, which bracket is horizontally pivotally mounted to a horizontal bracket fixed to the underside of the cabinet to allow the screen to fold between a horizontal stowed position under the cabinet and a generally vertical position for viewing. Normally some facility is also provided by the bracket assembly for swivelling the screen in its generally vertical position. Whilst many of these bracket assemblies are satisfactory for the smallest television sets, they are less satisfactory or unsuitable for sets with larger sized screens.

An object of the invention is to provide a mounting bracket in an improved and convenient form.

According to the invention there is provided a mounting bracket comprising a first bracket component adapted to be mounted at a surface, a second bracket component adapted to be engaged to a component to be mounted by the mounting bracket, in use, and a third bracket component in relatively slidable engagement with said first bracket component, and pivotally connected to said second bracket component.

Preferably the first bracket component is adapted to be indirectly mounted at said surface, in use, by means of an adaptor which is fixed to the surface, and relative to which the first bracket component can swivel. Desirably the first bracket component is of inverted lipped channel form and the third bracket component is of inverted channel form, received within the first bracket component with its respective opposite channel sides slidably engaged on said lips.

Most preferably means are provided for locking the second bracket component to the first bracket component when the second bracket component is in its stowed state. Desirably, at least one projection means on the second bracket component can be received through a cut out of the first bracket component and then retained by part of the first bracket component when the second bracket component is slid relative thereto.

Conveniently at a position along the length of the first bracket component part of each channel side thereof together with its associated lip is cut away, and more conveniently at a position along the length of the third bracket component part of each channel side thereof is similarly cut away. Advantageously said second bracket component has a pair of projections receivable through said respective cut outs of the first bracket component formed by said cutting away, and thereafter slidably engagable on said lips upon a sliding of said third bracket component to a stowed position relative to said first bracket component, thereby to retain the second bracket component, and thus the component mounted thereto, in use, in a locked position.

The invention will now be described, by way of example, with reference to the accompanying drawings, in which:

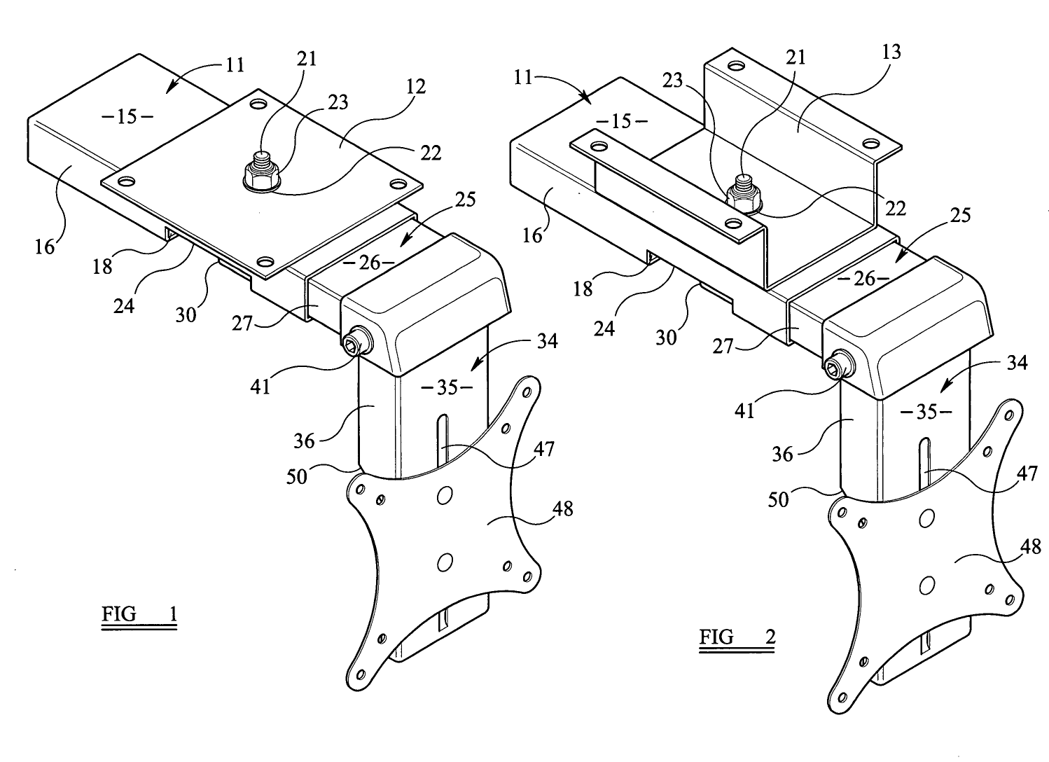

FIG. 1 is a perspective view of a first form of a mounting bracket of the invention,

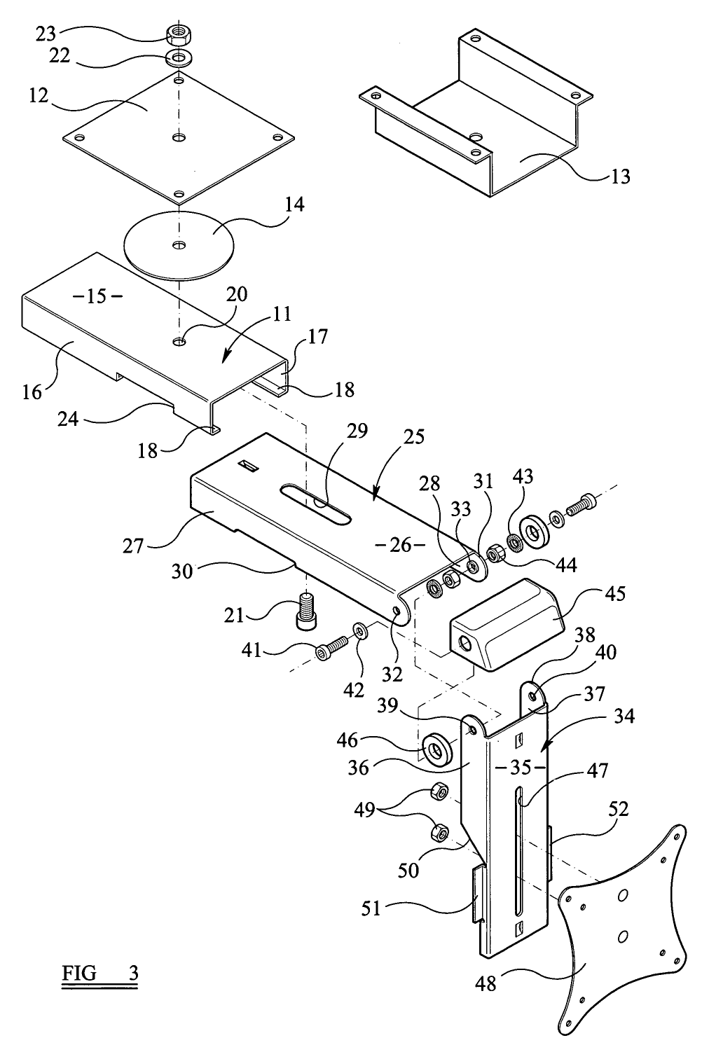

FIG. 2 is a perspective view of a second form of a mounting bracket of the invention,

FIG. 3 is an exploded perspective view of the components of the mounting brackets of FIGS. 1 and 2, and

FIGS. 4 to 7 are respective perspective views showing the stages in the folding up of an LC TV mounted to a mounting bracket of the invention, and its subsequent securement in a locked position.

Whilst the present invention will be described below, particularly in relation to FIGS. 4 to 7, by reference to the mounting under a surface of a liquid crystal television set, a mounting bracket of the invention can be used to mount not only such television sets, but also flat panel display screens in general, thus including computer monitors. Moreover although as illustrated in FIGS. 4 to 7, the television set is shown mounted, for simplicity, under a tabletop, a mounting bracket of the invention is particularly intended for use in a kitchen at the underside of a cabinet or shelf.

Whilst FIGS. 1 and 2 show two different embodiments of a mounting bracket of the present invention, the difference relates solely to the manner in which a first bracket component 11 is mounted to the underside of the surface in question. In FIG. 1 the component 11 is mounted to the undersurface (not shown) via a flat square plate 12, and this would normally be the arrangement where there is no pelmet or the like at the front underside of the mounting surface. However where such a pelmet or equivalent is provided, the plate 12 would be replaced by a different form of adaptor, namely an inverted, outwardly lipped channel element 13 shown in FIG. 2, which thereby displaces the component 11 downwardly so that, as will be described, a part of the mounting bracket can slide forwardly below the level of the front pelmet. As shown in FIG. 3, a swivel bearing component 14 would be provided between the component 11 and the plate 12 to enable the mounting bracket incorporating the component 11 to swivel relative to the fixed plate 12, and thus to the undersurface to which the plate 12 is fixed. Although not shown as such in FIG. 3, a swivel bearing component 14 would also be provided when the element 13 is used instead of the plate 12.

As shown in FIGS. 1 to 3, the first bracket component 11 is of inwardly lipped channel shape in cross-section, having a base 15, from which respective opposite side walls, 16, 17 extend at 90°, with respective lips 18, 19 extending inwardly at 90° from the side walls at the respective free ends thereof spaced from the base. The base has a central, circular hole 20 therethrough to receive, as shown, a bolt 21 which passes through respective aligned holes in the component 14 and plate 12, being locked by a washer 22 and nut 23. Respective holes in the four corners of the plate 12 are for fixing elements for securing the plate to the underside of the surface at which the mounting bracket is to be retained. The arrangement is similar for the element 13, in that it has central hole in its base to receive the bolt 21 and has fixing holes in its outward lips for fixing the element 13 to the undersurface. When the plate 12 is used as shown in FIG. 1, it will be understood that the undersurface can be recessed to receive the end of the bolt 21, washer 22, and nut 23.

As shown in FIGS. 1 to 3, at a position along the length of the component 11, part of each of its side walls and the whole of the respective lip associated therewith is cut away, the resultant cut out 24 extending for approximately one third of the height of each side wall. The purpose of this cutting away at the respective opposite sides of the component 11 is for a purpose to be described hereinafter.

Slidable within the component 11 is a second bracket component 25, which, like the component 11, could be metallic, for example steel, or of plastics material. The component 25 is of generally channel shape in cross section, being formed of a base 26 with respective opposite side walls 27, 28 depending downwardly therefrom at 90°. A curved ended slot 29 is provided in the base 26, centrally between the opposite side walls 27, 28, so as to be aligned with the central circular hole 20 in the component 11, in order to ensure that the component 25 can slide within the component 11 by allowing for the shank of the bolt 21 to be received through said slot during said sliding. Accordingly it is clear that initially the component 25 would be placed within the component 11 with the hole 20 in alignment with part of the slot 29 before insertion through the slot 29 and hole 20 of the bolt 21. Like the component 11, the side walls of the component 25 are cut away at a position along the length of the component 25, the resultant cut out being shown at 30 in the Figures, and being of similar form with the component 25 to the cut out 24 for component 11. Accordingly the component 25 can be slid within the component 11 to position where the cut out portions at the opposite sides of the component 11 are in alignment with the cut out portions at opposite sides of the component 25, for a purpose to be described hereinafter.

As seen from FIG. 3, the outermost end of the component 25 has its base cut back and the end edge surfaces of the side walls 27, 28 rounded as at 31, with these ends of the side walls 27, 28 being formed with inwardly plunged holes 32, 33 respectively.

These holes 32, 33 are for pivotally connecting to the second bracket component 25 a third bracket component 34 which, like the components 11 and 25 is preferably a metal pressing or stamping. The component 34 is, like the component 25, of generally channel cross section, being formed of a base 35 and opposite side walls 36, 37 respectively extending normally from the base. At its one end, the component 34 is formed identically to the outermost end of the component 25 in having its base 35 cut back and its side walls rounded, as at 38, and formed with respective holes 39, 40. The component 34 is sized such that its full depth side walls 36, 37 can be received within the channel defined by the component 25, and from FIG. 3 it can be seen that this is provided for by a pivotal connection of the component 34 to the component 25 by fixings passing through respective pairs of aligned holes 32, 39 and 33, 40 of the side walls 27 and 28 of the component 25 and side walls 36, 37 of the component 34, when the rounded ends of the side walls of the component 34 are fitted within the rounded ends of the side walls 27 and 28 of the component 25. As can be seen from FIG. 3, there is provided through each pair of aligned holes a bolt 41, washer 42, at one side, and a grip washer 43 and nut 44 at the other inner side of the pivot fixing. A plastics material or other cover 45 is slid onto the end of component 25 and fixed over the pivotal connection as shown best in FIGS. 1 and 2, with the bolt 41 also passing through this cover. A bearing washer 46 is disposed at each of the opposite sides of the bracket, between the components 25 and 34, the washers fitting on the inward plunged parts respectively of the holes 32,33.

The base 35 of the component 34 is formed with a central longitudinal slot 47 to allow a flat interface plate or mounting plate 48 to be adjustably secured to the outside of the base 35. The plate 48 has threaded means at one side thereof extending through the slot 47 to allow the plate to be secured in an adjusted position along the slot 47 by way of nuts 49. This plate is provided with fixing holes adapted to match fixing positions at the rear of the television set 10. The interface plate 48 will clearly be selected as required to match the hole pattern on the rear of the LCD screen to be mounted by the mounting bracket of the invention.

At a position along the respective opposite sides of the base 35, the depth of each side wall is significantly reduced, as shown in FIG. 3, with the full depth side wall in each case being angled down towards the base as shown at 50. However at the start of the reduced depth of the side walls, each side wall is integrally formed with an outwardly directed projecting rectangular wing, the two wings being denoted by the numerals 51, 52 respectively for the two side walls 36, 37 shown in FIG. 3. As can be seen in this Figure, each wing lies parallel to, but slightly spaced from the plane of the base 35. Beyond the wings, the side walls continue to the outer end of the component 34, at 90° to the base 35, but are of very short extent.

The longitudinal extent of each wing is such that it is slightly less than the longitudinal extent of the cut outs 24 and 30, whilst the outward extent of each wing is such that the total width across from the outer surface of one wing to the other is less than the spacing between the opposite internal side surfaces of the side walls 16, 17. In this way, as will be described, the wings can be swung up to pass through the cutaway portions 24 of the lips 18, 19, so that, as will be described, when the component 25 is slid rearwardly within the component 11, these wings 51, 52 respectively engage on and slide over the inner surfaces of the lips 18, 19, to ‘lock’ the component 34 to the component 11, thereby locking the television set 10 in its horizontal, stowed position underneath the undersurface to which the mounting bracket is secured.

Taken in conjunction with the above description, it is believed that FIGS. 4 to 7 clearly explain how a mounting bracket of the invention operates in use. Although it will be noted that the component 11 shown in FIGS. 4 to 7 has the cutaway part 24 extending to its outer end, this cutaway would preferably be formed as shown in FIGS. 1 to 3, where it does not extend to the free end but terminates short thereof. However it is believed that for the sake of explaining the operation, FIGS. 4 to 7 are still applicable.

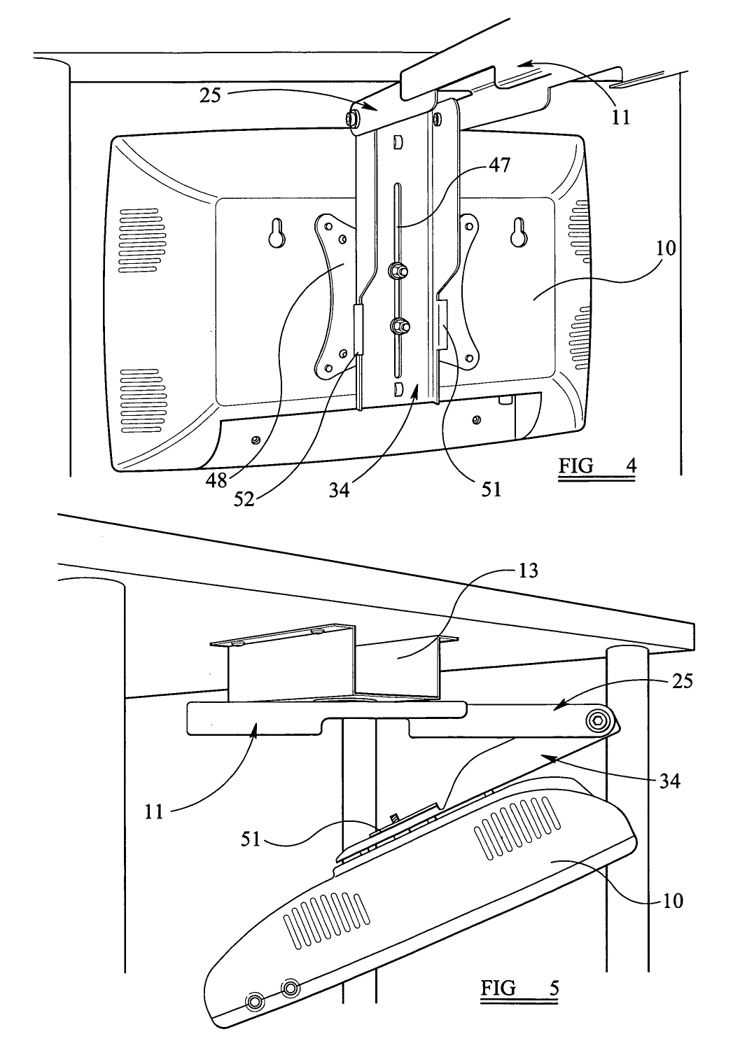

Accordingly FIG. 4 shows the arrangement where the second bracket component 25 has been pulled fully out of the first bracket component 11, until the shank of the bolt 21 is at the end of the slot 29 which is to the left as viewed in FIG. 3, the bolt thus acting as a stop to prevent the component 25 moving further to the right as viewed in FIGS. 1 to 3. With the component 25 in its outward position, it can be seen that the component 34 has been pivoted downwardly to lie generally vertically so that the television set 10 secured thereto by way of the mounting plate 48 is also generally vertical with its visible surface facing out into the kitchen or other room in which the undersurface of the cabinet, shelf or the like is provided. It may be possible in this position for the pivoting to be continued slightly past the vertical, so as slightly upwardly to incline the screen, and of course it is possible for it to be pivoted rearwardly in the direction of pivoting shown in FIG. 5, although normally the screen would be viewed vertically. In this state it is possible to swivel the bracket about the adapter element 13 shown in this embodiment, although the pelment covering the front of the undersurface to which the bracket is retained is not shown for clarity. This swivelling would also be possible with the alternative arrangement using the plate 12 of FIG. 1. It will be appreciated that with the component 25 pulled fully out of the component 11 to its extreme stop position, the screen will generally be forward of the surface to which the element 13 is secured, though this will clearly depend upon exactly where the element 13 is fitted at the undersurface relative to the front thereof. This in turn will depend to some extent upon the size of the television set to be mounted. As will be understood, the position of the set relative to the component 34 will be adjusted as required by the use of the mounting plate 48 and the slot 47 in the component 34.

Whilst with various known devices the bracket connected to the television set is merely pivoted to the bracket at the undersurface, the present arrangement provides the additional sliding bracket component 25 which not only enables the screen to be pulled well forward from under the mounting surface, but it also likewise enables the screen to be slid so that it can be received completely under the surface even if it is of a relatively large screen size, in contrast to known arrangements where, without such sliding, part of the screen may project forward of the undersurface even in its stowed state, or may in fact prevent the use of larger sized screens, for example larger than the smallest 11 inch (27.94 cm) screens.

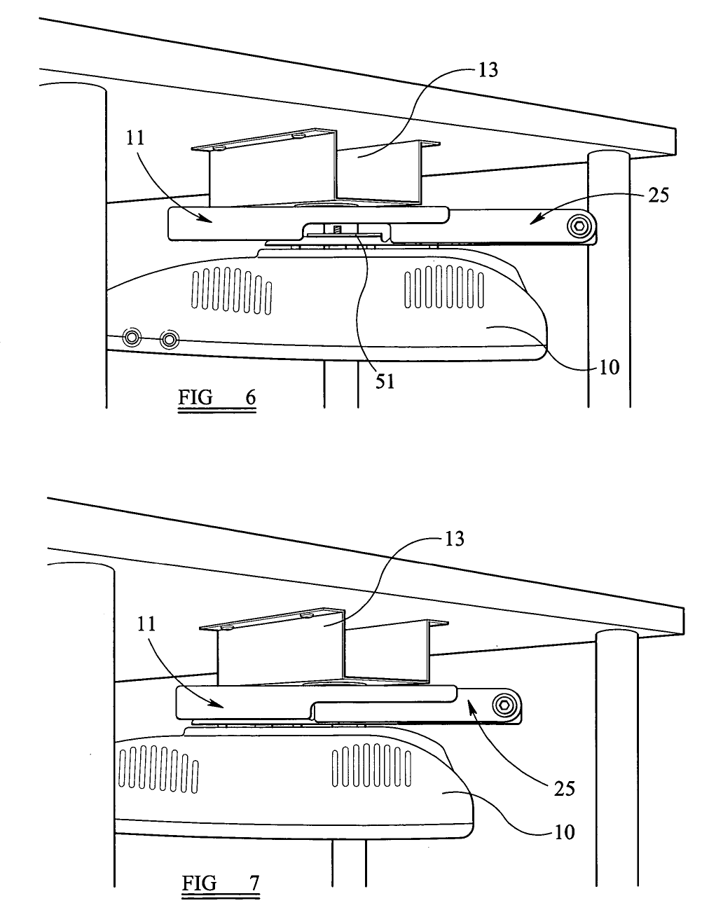

To stow the screen from its FIG. 4 position, it is possible to both pivot the screen upwardly, as shown in FIG. 5, and also to push the component 25 slidably inwardly with its side walls 27, 28 sliding on the lips 18, 19 of the component 11. Regardless of which of these movements is carried out, and regardless of whether or not they are initially carried out together, it is important that when the wings 51, 52 of component 34 reach the horizontal, the cutout portions 30 of the component 25 are in alignment of the cut out portions 24 of the component 11 as shown in FIG. 6. This alignment of these cut out portions allows the wings to be received upwardly into the overlapping parts of the components 11 and 25 respectively, with the wings lying slightly above the level of the respective inner surfaces of the lips 18 and 19. Accordingly with the set supported upwardly in its FIG. 6 position, and the wings slightly above the inner surfaces as mentioned, it is then possible to push rearwardly together the two components 34 and 25 so that not only do the side walls 27, 28 of the component 34 slide over the lips, but additionally the wings 51, 52 slide over said lips until the fully stowed position showing FIG. 7 is reached where the component 25, and thus also the component 34, are received as fully as possible in the component 11. It will thus be appreciated that once the wings leave the aligned cut out portions 24 and 30, they are held or locked from downward movement by the lips 18, 19, so that the screen itself is ‘locked’ in this stowed position shown in FIG. 7. Accordingly, unlike known brackets for securing an LCD screen to the underside of a cabinet or a shelf, the bracket of the present invention does not rely soley upon friction in the pivot about which the screen is horizontally movable to retain the screen in its stowed position, and instead provides a positive mechanical lock as a particularly advantageous preferable feature. However as stated above, the important feature of the present invention is the provision of the sliding component of the bracket which increases its versatility. In particular it will be noted that whilst the invention allows larger sized screens to be used, the improvement does not affect the other bracket functions, for example the swivelling which is still possible both when the component 34 is locked and also when it is unlocked from the component 11, again in contrast with certain known brackets.

1. A mounting bracket comprising a first bracket component adapted to be mounted at a surface, a second bracket component adapted to be engaged to a component to be mounted by the mounting bracket, in use, and a third bracket component in relatively slidable engagement with said first bracket component, and pivotally connected to said second bracket component.

2. A bracket as claimed in claim 1, wherein the first bracket component is adapted to be indirectly mounted at said surface, in use, by means of an adaptor which is fixed to the surface, and relative to which the first bracket component can swivel.

3. A bracket as claimed in claim 1, wherein the first bracket component is of inverted lipped channel form and the third bracket component is of inverted channel form, with at least part of its length being receivable within the first bracket component with its respective opposite channel sides slidably engaged on said lips.

4. A bracket as claimed in claim 1, wherein means are provided for locking the second bracket component to the first bracket component when the second bracket component is in its stowed state.

5. A bracket as claimed in claim 4, wherein at least one projection means on the second bracket component can be received through a cut out of the first bracket component and then retained by part of the first bracket component when the second bracket component is slid relative thereto.

6. A bracket as claimed in claim 3, wherein at a position along the length of the first bracket component part of each channel side thereof together with its associated lip is cut away.

7. A bracket as claimed in claim 6, wherein at a position along the length of the third bracket component part of each channel side is cut away similarly to said cutting away of the first bracket component.

8. A bracket as claimed in claim 7, wherein said second bracket component has a pair of projections receivable through respective cut outs of the first bracket component formed by said cutting away, and thereafter slidably engageble on said lips upon a sliding of said third bracket component to a stowed position relative to the first bracket component, thereby to retain the second bracket component, and thus the component mounted thereto, in use, in a locked position.

9. A bracket as claimed in claim 3, wherein one end of the third bracket component remains outside of the first bracket component when the remainder of the third bracket component is received within the first bracket component, and said one end is pivotally connected to one end of the second bracket component.
